(19) United States
(12) Patent Application Publication
(10) Pub. No.: US 2007/0065035 A1
(43) Pub. Date: Mar. 22, 2007

(54) Image processing method and two-dimension discrete cosine transformation device using the same

(76) Inventor: Fu-Chung Chi, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/508,974

(22) Filed: Aug. 24, 2006

(30) Foreign Application Priority Data
Sep. 20, 2005 (TW) 94132449

(51) Int. Cl. G06K 9/00; G06K 9/36

(52) U.S. Cl. 382/251; 382/250

(57) ABSTRACT

An image processing method and a two-dimension discrete cosine transformation device using the same method are provided. The method includes steps of reading an image pixel data block, converting the data of the image pixel data block in the form of a frequency domain, limiting the converted data in the form of the frequency domain into a first predetermined number of bits, rearranging original DC values and original AC values, distributing the number of bits of the original DC values and the original AC values, quantifying the original DC values and the original AC values, and storing the quantified DC values and AC values into a memory. The device using the aforementioned method includes a first one-dimension cosine transformation unit connected to a transformation register further connected to a second one-dimension cosine transformation unit and a multiplier unit for receiving outputs from the second one-dimension cosine transformation unit.

### BACKGROUND OF THE INVENTION

1. Field of the Invention

The present invention relates to an image processing method, and more particularly, to an image processing method using the discrete cosine transformation and quantification procedure.

2. Description of Prior Arts

MPEG image compression method is directed at reducing the size of a segment of a clip consisted of a series of images. Because of the similarities between adjacent images (i.e. there are some correlations between these images), the first step of this specific compression method is to look for images with correlations (similarities). Once these images with correlations are found the method will delete correlation parts in terms of time between images or the correlation part in terms of space in any given image, in order to reduce the size of the data. Then the method would weed out part of images insensible to ordinary human eyes, thereby further reducing the size of the data. MPEG data compression method is carried out by discarding the data insensible to human eyes along with the playing of the clip, therefore the entire image quality would stay unaffected.

MPEG compression integrates the motion compensation-based time-axis compression and the frequency coefficient, which is generated by discrete cosine transform (DCT), encoding and quantification-based spatial-axis compression. As for the time-axis compression, three pictures including intra-coded picture (I-Picture), predictive-coded picture (P-Picture), and bi-directionally predictive-coded picture (B-Picture) would be generated. I-Picture represents the primary part of the image and records the entire information of the image while P-Picture and B-Picture are for recording the difference of pictures only by having P-Picture compare with I-Picture and B-Picture compare with I-Picture and P-Picture.

However, MPEG compression would delete duplicated image blocks in terms of time domain while corresponding motion vectors of P-Pictures or B-Pictures would bring image blocks from decompressed images back and add them up, meaning three or four frame buffers for the motion compensation purpose would be required in the chip.

Unfortunately, with more frame buffers placed inside a chip the chip would take more space, which is not consistent with the current trend of chip size reduction. As the result, if we can have one image compression performed on the image data before they are written to frame buffers and one image decompression performed for these image data before having the motion compensation executed the entire size of the chip would be somewhat reduced while the total amount of inputted/outputted data of the memory would be reduced as well, therefore making the entire chip more power efficient.

Adaptive Differential Pulse Code Modulation (ADPCM) tried to take advantage of the characteristic of continuity of images in any given clip. Any pixel and pixels around theoretically posses a certain degree of similarity, and therefore ADPCM subtracted pixels in the neighborhood, camp up with differences of these pixels, and then quantified these differences. Assume we have pixel A and pixel B in the neighborhood of pixel A, ADPCM subtracted A from B (or vice versa) to obtain the difference between pixels A and B, considered pixels A and B as one set of pixels and stored this set of pixels in terms of pixel A (if ADPCM subtracted pixel A from pixel B) or pixel B (if vice versa), a quantification index, and the quantified difference between pixels A and B, into the memory. When it comes to decoding, the quantification index and either pixel A or B (depend on which one is subtracted) would be retrieved first and the quantified difference would be added back to pixel A or B. ADPCM was relatively simple but tits efficiency of data compression was compromised and some high distortion would take place especially in the case of non-continuous images.

One-dimension MHT was an alternative to MPEG compression. After having DC values and AC values, a built-in quantification table would be used to quantify these DC and AC values. However the efficiency of one-dimension MHT method was very similar to that of ADPCM, meaning high distortions would take place at non-continuous junctures of images.

### SUMMARY OF INVENTION

It is therefore a primary objective of the present invention to provide an image processing method for reducing the number of placement of frame buffers.

In accordance with claimed invention, the present image processing method includes steps of reading an image pixel data block, converting the data of the image pixel data block in the form of a frequency domain, limiting the converted data in the form of the frequency domain into a predetermined number of bits, rearranging original DC values and original AC values, distributing the number of bits of the original DC values and the original AC values, quantifying the original DC values and the original AC values, and storing the quantified DC values and AC values into a memory.

The present invention further provides a two-dimension discrete cosine transformation device using the above image compression method. The device includes a first one-dimension discrete cosine transformation operation unit, a transformation register connected to the first one-dimension discrete cosine transformation unit for storing outputs from the first one-dimension cosine transformation unit, a second one-dimension discrete cosine transformation unit connected to the transformation register for reading data from the transformation register, and a multiplier units having four multipliers for receiving four outputs respectively from the second one-dimension discrete cosine transformation unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing a hardware structure of a one-dimension cosine transformation unit according to the present invention.

FIG. 2 is a schematic diagram showing a hardware structure implementing the two-dimension discrete cosine transformation according to the present invention.

FIG. 3 is a schematic diagram showing a preferred embodiment zigzag-scanning table according to the present invention.

FIG. 4 is a flow chart showing an image compression process according to the present invention.

FIG. 5 is a flow chart showing an image decompression process according to the present invention.

### DETAILED DESCRIPTION OF THE PREFERRED EMBODIMENT

H. 264-defined 4×4 two-dimension discrete cosine transformation (DCT) has the result similar to that of float point discrete cosine transformation and significantly reduces the number of bits required in performing DCT image compression. As the result, hardware for implementing 4×4 two-dimension DCT could be reduced in size. With this characteristic, dividing every image going to be written into the frame buffer to several 4×4 pixel blocks and then performing discrete cosine transformation on these 4×4 pixel blocks would be a viable alternative to aforementioned prior art methods.

H. 264-defined discrete cosine transformation formula is as formula (1):

$$Y = {C}_{f} {XC}_{f}^{T} ⊗ {E}_{f} = ( [ \begin{matrix}1 & 1 & 1 & 1 \\ 2 & 1 & - 1 & - 2 \\ 1 & - 1 & - 1 & 1 \\ 1 & - 2 & 2 & - 1\end{matrix} ] [ X ] [ \begin{matrix}1 & 2 & 1 & 1 \\ 1 & 1 & - 1 & - 2 \\ 1 & - 1 & - 1 & 2 \\ 1 & - 2 & 1 & - 1\end{matrix} ] ⊗ [ \begin{matrix}{a}^{2} & \frac{ab}{2} & {a}^{2} & \frac{ab}{2} \\ \frac{ab}{2} & \frac{{b}^{4}}{4} & \frac{ab}{2} & \frac{{b}^{4}}{4} \\ {a}^{2} & \frac{ab}{2} & {a}^{2} & \frac{ab}{2} \\ \frac{ab}{2} & \frac{{b}^{4}}{4} & \frac{ab}{2} & \frac{{b}^{4}}{4}\end{matrix} ] )$$

Matrix X is a timing signal of the image pixel data block, and matrix C_{f} is a parameter matrix. An inverse discrete cosine transformation formula defined in H. 264 is as formula (2):

$${Y}^{′} = {C}_{i}^{T} ( Y ⊗ {E}_{i} ) {C}_{i} = [ \begin{matrix}1 & 1 & 1 & \frac{1}{2} \\ 1 & \frac{1}{2} & - 1 & - 1 \\ 1 & - \frac{1}{2} & - 1 & 1 \\ 1 & - 1 & - & - \frac{1}{2}\end{matrix} ] ( [ X ] ⊗ [ \begin{matrix}{a}^{2} & ab & {a}^{2} & ab \\ ab & {b}^{2} & ab & {b}^{2} \\ {a}^{2} & ab & {a}^{2} & ab \\ ab & {b}^{2} & ab & {b}^{2}\end{matrix} ] ) [ \begin{matrix}1 & 1 & - & 1 \\ 1 & \frac{1}{2} & - \frac{1}{2} & - 1 \\ 1 & - 1 & - 1 & - \\ \frac{1}{2} & - 1 & 1 & - \frac{1}{2}\end{matrix} ]$$

wherein a=1/2, b=(2/5) ^{1/2}, Eᵢ is a pure number matrix for insuring the absolute value of the inverse discrete cosine transformation is equal to 1. With the setting of the matrix Eᵢ the number of multipliers would be reduced while Y′ is substantially equal to X.

After having the discrete cosine transformation and before performing the inverse cosine discrete cosine transformation, inner products are necessary (from the standpoint of formulas (1) and (2)). Matrix Eᵢ and E_{f} have all values therein less than 1 and after having inner products performed the outcome of inner products would become smaller which achieves the goal of minimizing values to be written into frame buffers. As the result, the compression rate would be more efficient. If combining Eᵢ and E_{f} together into one single matrix Eₘ which could be defined as formula (3) as follows:

$${E}_{m} = [ \begin{matrix}\frac{1}{4} & \frac{1}{2} {b}^{2} & \frac{1}{4} & \frac{1}{2} {b}^{2} \\ \frac{1}{2} {b}^{2} & {b}^{4} & \frac{1}{2} {b}^{2} & {b}^{4} \\ \frac{1}{4} & \frac{1}{2} {b}^{2} & \frac{1}{4} & \frac{1}{2} {b}^{2} \\ \frac{1}{2} {b}^{2} & {b}^{4} & \frac{1}{2} {b}^{2} & {b}^{4}\end{matrix} ]$$

Then the inverse cosine transformation could be rewritten as formula (4):

$${Y}_{4} = {C}_{f} {XC}_{f}^{T} ⊗ {E}_{m} = ( [ \begin{matrix}1 & 1 & 1 & 1 \\ 2 & 1 & - 1 & - 2 \\ 1 & - 1 & - 1 & 1 \\ 1 & - 2 & 2 & - 1\end{matrix} ] [ X ] [ \begin{matrix}1 & 2 & 1 & 1 \\ 1 & 1 & - 1 & - 2 \\ 1 & - 1 & - 1 & 2 \\ 1 & - 2 & 1 & - 1\end{matrix} ] ⊗ [ \begin{matrix}\frac{1}{4} & \frac{1}{2} {b}^{2 } & \frac{1}{4} & \frac{1}{2} {b}^{2 } \\ \frac{1}{2} {b}^{2 } & {b}^{4} & \frac{1}{2} {b}^{2 } & {b}^{4} \\ \frac{1}{4} & \frac{1}{2} {b}^{2 } & \frac{1}{4} & \frac{1}{2} {b}^{2 } \\ \frac{1}{2} {b}^{2 } & {b}^{4} & \frac{1}{2} {b}^{2 } & {b}^{4}\end{matrix} ] )$$

As the result, at the time of performing discrete cosine transformation the presence of Eₘ (for the purpose of inner products) would help minimize values and therefore they could be stored to frame buffers smaller in size. On the other hand, no Eₘ is required when the inverse discrete cosine transformation is performed. After having inner products performed with matrix Eₘ the present compression method restricts the outcome between −256 and 255 (i.e. 9 bits are sufficient to represent every value), leading to small differences between quantified and non-quantified values.

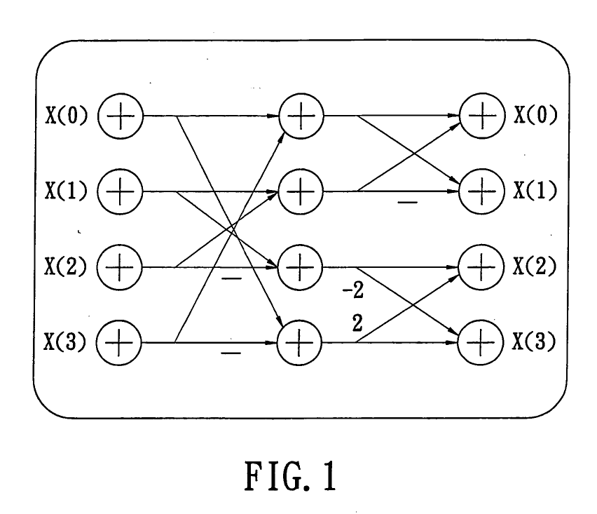

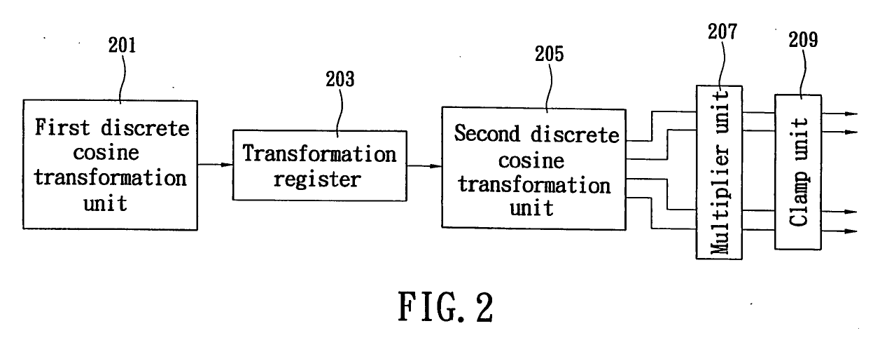

Please refer to FIG. 1 of a schematic diagram showing a hardware structure of the present invention one-dimension discrete cosine transformation unit for executing matrix operations with adders, subtractors, and displacement elements. On the basis of FIG. 1, ordinary skilled in the art would be able to come up with a schematic diagram (as shown in FIG. 2) of implementing a two-dimension discrete cosine transformation. As having original image values enter into the first discrete cosine transformation unit 201, the present invention method writes the outcome into the transformation register 203 in a horizontal manner and has the second discrete cosine transformation unit 205 read the outcome out of the transformation register 203 in a vertical manner. The transformation register 203 preferably is a 4×4 register. The second discrete cosine transformation unit 205 outputs 4 values at once to the respective multipliers of the multiplier unit 207. The multiplier each leftward shifts outputs from the second discrete cosine transformation unit 205, deletes the decimal fraction part after the shifting, and adds the remaining integer part in terms of binary form. For example, b² /2=0.2, in hardware implement, the value would be shift left to integer value. If we shift left 10 bit, the value is 204.8, truncate to integer value 205. So the 205=128+64+8+4+1. The multiply could be decrease to 5 adder. Outputs from the multipliers would be limited between −256 and 255 by the clamp unit 209, meaning only 9 bits would be necessary to represent these outputs (in terms of binary form).

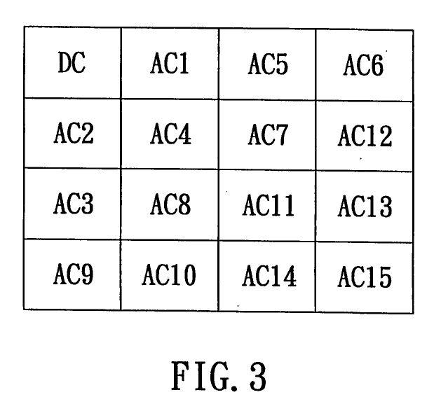

4×4 two-dimension discrete cosine transformation converts the image data from the time domain to the frequency domain and then zigzag scanning will be used to rearrange the rank of all frequencies in order to distinguish AC values with higher or lower frequencies. A preferred embodiment of a zigzag-scanning table as shown in FIG. 3 has a DC value placed the top left corner thereof and AC values arranged from ACI representing the AC value with lowest frequency to AC 15 representing the AC value with highest frequency so as to distribute certain number of bits to AC values. One zigzag-scanning table has 16 entries (128 bits in total) and if the frame buffer is going to have a 64-bit storage (with 50 percent compression rate) and the standing alone DC value is quantified directly in terms of a 7-digit value without any compression, plus one 3-digit quantification index, only 54 (64 minus 7 minus 3) would be left for AC values. AC values with lower frequencies are going to be distributed more digits, AC values with higher frequencies are going to be distributed less digits, and the AC value with highest frequency will be deleted.

Preferably, there are six quantification tables for quantifying the converted AC values in order to have corresponding quantified AC values and the entire process starts with the first quantification table. If the first quantification table fails to quantify all AC values into the quantified form suitable to be stored into the memory, the present invention image compression method will turn to next quantification table and so on if failures continue to take place. The final quantification table is designed to place all quantified AC values into the memory. The original DC value is simply rightward shifted into a 7-digit form. Thereafter, quantified DC and AC values plus one quantification index serving as an index signal for assigning quantification tables are written into the memory to complete the entire compression process.

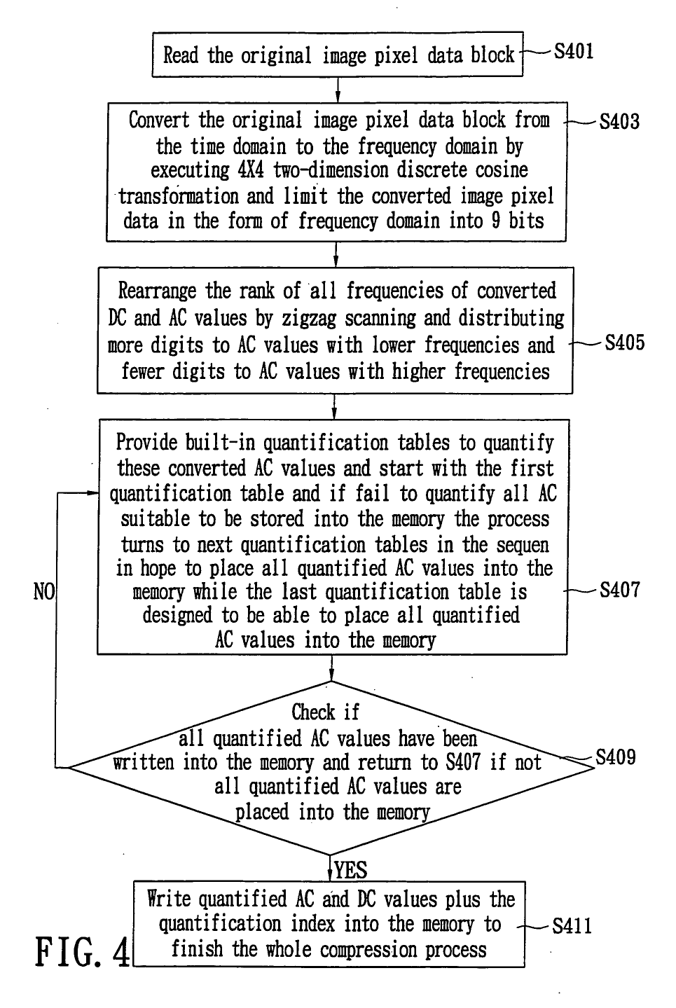

The entire compression process is shown in FIG. 4 illustrating an image compression flow chart according to the present invention. S401 reads the original image pixel data block, S403 converts the original image pixel data block from the time domain to the frequency domain by executing 4×4 two-dimension discrete cosine transformation and limits the converted image pixel data in the form of frequency domain into the first predetermined number of bits wherein the first predetermined number is nine (9); S405 rearranges the rank of all frequencies of converted DC and AC values by zigzag scanning and distributing more digits to AC values with lower frequencies and fewer digits to AC values with higher frequencies; S407 provides built-in quantification tables to quantify these converted AC values and starts with the first quantification table and if fails to advance the purpose of quantifying all AC values suitable to be stored into the memory the process turns to next quantification tables in the sequence in hope to place all quantified AC values into the memory while the last quantification table is designed to be able to place all quantified AC values into the memory; S409 checks if all quantified AC values have been written into the memory and returns to S407 if not all quantified AC values are placed into the memory; and S411 writes quantified AC and DC values plus the quantification index into the memory to finish the whole compression process.

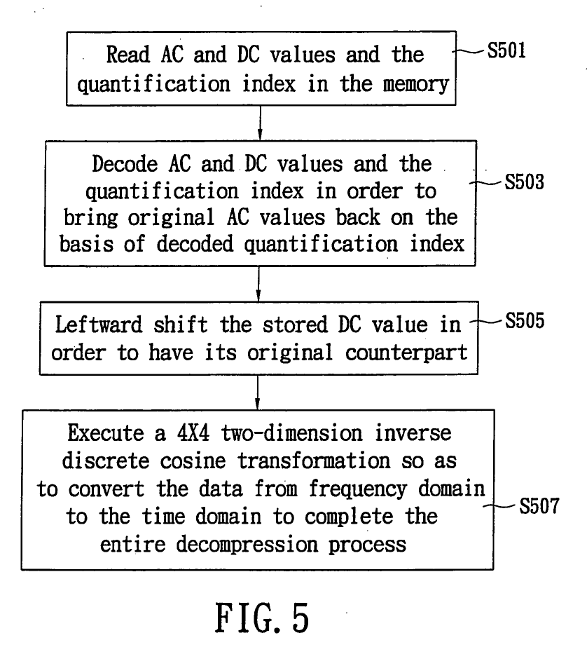

The decompression process could be regarded as a mirror image of its compression counterpart. Please refer to FIG. 5 of a flow chart showing a preferred embodiment of image decompression process according to the present invention. S501 reads AC and DC values and the quantification index in the memory; S503 decodes AC and DC values and the quantification index in order to bring original AC values back on the basis of decoded quantification index; S505 leftward shifts the stored DC value in order to have its original counterpart; and S507 executes a 4×4 two-dimension inverse discrete cosine transformation so as to convert the data from frequency domain to the time domain to complete the entire decompression process.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An image processing method, comprising:
reading an image pixel data block;
converting the data of the image pixel data block in the form of a frequency domain;
limiting the converted data in the form of the frequency domain into a first predetermined number of bits;
rearranging original DC values and original AC values;
distributing the number of bits of the original DC values and the original AC values;
quantifying the original DC values and the original AC values; and
storing the quantified DC values and AC values into a memory.

2. The image processing method in claim 1 wherein converting the data of the pixel data block in terms of the frequency domain representation is by employing a 4×4 two-dimension discrete cosine transformation (DCT).

3. The image processing method in claim 2 wherein the 4×4 two-dimension discrete cosine transformation is
$${C}_{f} {XC}_{f}^{T} ⊗ {E}_{m} = ( [ \begin{matrix}1 & 1 & 1 & 1 \\ 2 & 1 & - 1 & - 2 \\ 1 & - 1 & - 1 & 1 \\ 1 & - 2 & 2 & - 1\end{matrix} ] [ X ] [ \begin{matrix}1 & 2 & 1 & 1 \\ 1 & 1 & - 1 & - 2 \\ 1 & - 1 & - 1 & 2 \\ 1 & - 2 & 1 & - 1\end{matrix} ] ⊗ [ \begin{matrix}\frac{1}{4} & \frac{1}{2} {b}^{2} & \frac{1}{4} & \frac{1}{2} {b}^{2} \\ \frac{1}{2} {b}^{2} & {b}^{4} & \frac{1}{2} {b}^{2} & {b}^{4} \\ \frac{1}{4} & \frac{1}{2} {b}^{2} & \frac{1}{4} & \frac{1}{2} {b}^{2} \\ \frac{1}{2} {b}^{2} & {b}^{4} & \frac{1}{2} {b}^{2} & {b}^{4}\end{matrix} ] )$$
wherein matrix X is a timing signal of the image pixel data block, matrix C_{f} is a parameter matrix, and matrix Eₘ is a combination matrix while b is equal to (2/5)^{1/2}.

4. The image processing method in claim 2 further comprising a step of executing operations of inner products by a multiplier and steps of leftward shifting the converted data in the form of frequency domain a second predetermined number of bits, deleting the decimal fraction thereof after the shifting, representing the remaining integer part in a binary form, and having an adder to add up the integer part in the binary form.

5. The image processing method in claim 1 wherein the first predetermined number is nine (9).

6. The image processing method in claim 5 wherein limiting the converted data in the form of frequency domain into 9 bits is implemented by a clamp unit.

7. The image processing method in claim 1 wherein rearranging the original DC values and the original AC values is by performing a zigzag scanning.

8. The image processing method in claim 7 wherein the zigzag scanning is performed on a basis of 4×4 pixel block in size.

9. The image processing method in claim 1 wherein distributing the number of bits of the original DC values and the original AC values is by fixed-encoding.

10. The image processing method in claim 1 wherein distributing the number of bits of the original DC values is to rightward shift the original DC values into a 7-digit form.

11. The image processing method in claim 1 wherein distributing the number of bits of the original AC values provides the original AC values having higher frequencies with a lower number of bits and the original AC values having lower frequencies with a higher number of bits.

12. The image processing method in claim 1 wherein distributing the number of bits of the original AC values directly deletes the original AC value having the highest frequency.

13. The image processing method in claim 1 wherein quantifying the original AC values and the original DC values is by six quantification tables.

14. The image processing method in claim 13 wherein the quantifying the original AC values and the original DC values first employs the first quantification table and turns to the remaining quantification tables in sequence if the application of the first quantification table fails to generate the quantified AC values suitable to be stored into the memory.

15. The image processing method in claim 13 wherein at least one of the six quantification table is capable of generating all the quantified AC values suitable to be stored into the memory.

16. The image processing method in claim 1 further comprising a step of storing a quantification index table along with one quantified DC value and a plurality of quantified AC values.

17. A image processing decompressing method, comprising:
reading a memory information;
decoding the retrieved memory information;
restoring the decoded memory information into original AC values and
original DC values; and
converting frequency domain signals into time domain signals.

18. The image processing method in claim 17 wherein the memory information includes a quantified DC value, a plurality of quantified AC values, and a quantified index.

19. The image processing method in claim 18 wherein restoring the decoded memory information into the original AC values and the original DC values is based on the quantification index.

20. The image processing method in claim 19 wherein restoring the decoded memory information into the original DC values is to leftward shift one bit of the quantified DC value.

21. The image processing method in claim 17 wherein converting the frequency domain signals into the time domain signals is by employing a 4×4 inverse discrete cosine transformation.

22. A two-dimension discrete cosine transformation device, comprising:
a first one-dimension discrete cosine transformation operation unit;
a transformation register connected to the first one-dimension discrete cosine transformation unit for storing outputs from the first one-dimension cosine transformation unit;
a second one-dimension discrete cosine transformation unit connected to the transformation register for reading data from the transformation register; and
a multiplier units having four multipliers for receiving four outputs respectively from the second one-dimension discrete cosine transformation unit.

23. The two-dimension discrete cosine transformation device in claim 22 wherein the first one-dimension cosine transformation unit writes data into the transformation register in a horizontal manner.

24. The two-dimension discrete cosine transformation device in claim 22 wherein the second one-dimension discrete cosine transformation unit reads data from the transformation register in a vertical manner.

25. The two-dimension discrete cosine transformation device in claim 22 further comprising a clamp unit for restricting bit numbers of values after having a two-dimension discrete cosine transformation performed.

26. The two-dimension discrete cosine transformation device in claim 25 wherein the clamp unit further includes four clamp devices respectively connected to the multipliers.

27. The two-dimension discrete cosine transformation device in claim 22 wherein the first one-dimension discrete cosine transformation unit further includes at least one adder, at least one subtractor, and at least one bit-shifting device.

28. The two-dimension discrete cosine transformation device in claim 22 wherein the second one-dimension discrete cosine transformation unit includes at least one adder, at least one subtractor, and at least one bit-shifting device.
